(19) United States
(12) Patent Application Publication
(10) Pub. No.: US 2025/0337307 A1
(43) Pub. Date: Oct. 30, 2025

(54) Drive Exciter and Electronic Device

(71) Applicant: Goertek Inc., Weifang, Shandong (CN)

(72) Inventors: Haiyang Ding, Shandong (CN); Hiroyuki Kobayashi, Weifang, Shandong (CN); Tomokuni Wauke, Shandong (CN)

(73) Assignee: Goertek Inc., Weifang, Shandong (CN)

(21) Appl. No.: 18/870,730

(22) PCT Filed: Nov. 4, 2022
(86) PCT No.: PCT/CN2022/129993

§ 371 Date: Dec. 2, 2024

(30) Foreign Application Priority Data
May 31, 2022 (CN) 202210612042.5

(51) Int. Cl. H02K 33/00; H02K 7/102

(52) U.S. Cl. CPC H02K 33/00; H02K 7/102

(57) ABSTRACT

The disclosure discloses a drive exciter and an electronic device. The drive exciter includes a bracket, a vibration part, a braking part and a latch part, and the bracket includes an installation member and a guiding structure connected to the installation member; the vibration part is movably connected to the guiding structure and is provided with a vibratile vibration member; the braking part is connected to the installation member and is provided towards the vibration part; and the latch part includes a drive member connected to the installation member and a latch member connected to an output end of the drive member.

### CROSS-REFERENCE TO RELATED APPLICATIONS

The present disclosure is a National Stage of International Application No. PCT/CN2022/129993, filed on Nov. 4, 2022, which claims priority to a Chinese patent application No. 202210612042.5 filed with the CNIPA on May 31, 2022, both of which are hereby incorporated by reference in their entireties.

### TECHNICAL FIELD

The present disclosure relates to the technical field of a vibration apparatus, and particularly to a drive exciter and an electronic device.

### BACKGROUND

A traditional vibration apparatus produces an illusion of a force “seemingly directed in a certain direction” by continuously producing asymmetric vibrations. However, to create this illusion, not only does the skin need to undergo shear deformation, which restricts the way the device can be held, but it is also necessary to limit the vibration frequency to a perceptible range, and the stimulation must be continued for a period of time

As a means of reproducing force sensations, there is now a method to input an asymmetric signal to a linear resonator and use the human senses to generate the illusion. This method, in principle, can only produce a continuous directional force sensation and cannot achieve discrete vibration outputs. The equivalent force perceived through this method is relatively small, and the asymmetric signal also generates excessive vibrations, making it difficult to obtain a clear direction-sense.

In summary, the conventional vibration apparatus has many limitations in practical application that are not limited to the above problems.

### SUMMARY

The main objective of the present disclosure is to provide a drive exciter, intended to discretely present clear and distinct anisotropic vibrations.

To achieve the above objective, the present disclosure proposes a drive exciter, including:

a bracket including an installation member and a guiding structure connected to the installation member;

a vibration part movably connected to the guiding structure and provided with a vibratile vibration member;

a braking part connected to the installation member and provided towards the vibration part; and

a latch part including a drive member connected to the installation member and a latch member connected to an output end of the drive member;

the drive exciter has a first state where the latch member abuts against the vibration part and a second state where the latch member is disengaged from the vibration part, and in the second state, the vibration part moves towards the braking part and abuts against the braking part.

In one embodiment of the present disclosure, the latch part includes two latch members, which are located on two sides of the vibration part to form a limiting space, with the drive member connected to at least one of the latch members;

wherein in the first state, the vibration part is limited within the limiting space.

In one embodiment of the present disclosure, the drive member is provided with a rotation shaft, with the latch member being a locking rod, one end of the latch member being connected to the rotation shaft, and a length direction of the latch member being arranged at an angle with an extension direction of the rotation shaft.

In one embodiment of the present disclosure, the bracket further includes a first connecting rack parallel to the guiding structure, the first connecting rack being connected to the installation member, and the drive member being fixed to the first connecting rack; and

the latch part further includes a limiting member which is connected to the first connecting rack and forms a limiting groove, a sidewall of the limiting groove being formed with a notch facing towards the vibration part, one end of the latch member connected to the drive member extending into the limiting groove, the other end of the latch member away from the drive member protruding out of the notch, and the latch member being rotated between two opposing sidewalls of the notch.

In one embodiment of the present disclosure, the guiding structure includes at least two guiderods extending along a vibration direction of the vibration member, and ends of the guiderods are fixed to the installation member;

the vibration part includes:

a housing provided with a shaft liner at a side surface thereof, the shaft liner being movably sleeved on the guiderod, and the housing enclosing a vibration space;

a vibration member provided within the vibration space vibrationally; and

two elastic members provided on two sides of the vibration member along the vibration direction of the vibration member, the elastic member being connected to the housing and an end of the vibration member.

In one embodiment of the present disclosure, the vibration part further includes a first yoke plate and a second yoke plate which are oppositely provided and are fixedly connected to the housing, the elastic member is a spring leaf, one end of the spring leaf is connected to the first yoke plate or the second yoke plate, the other end of the spring leaf is connected to the end of the vibration member;

and/or, an end of the housing along the vibration direction of the vibration member is provided with a cushioning member facing towards the braking part.

In one embodiment of the present disclosure, the drive exciter further includes a resetting member, which is a spring, and two ends of the spring are elastically connected to the vibration part and a surface of the installation member.

In one embodiment of the present disclosure, the braking part is a spring;

or, the braking part is rubber;

or, the braking part is foam;

or, the braking part is composed of at least two of a spring, rubber, and foam connected in series or in parallel.

In one embodiment of the present disclosure, the drive exciter includes two installation members opposite to each other, two braking parts opposite to each other, and two latch parts opposite to each other, with two ends of the guiding structure connected to the two installation members;

the two braking parts are oppositely provided on the two installation members;

two latch parts are provided in parallel on two sides of the vibration part, one drive member is connected to one latch member, and each latch member is provided between the vibration part and the installation member to form a limiting space;

wherein in the first state, the vibration part is limited within the limiting space.

The present disclosure further relates to an electronic device, which includes the drive exciter according to any one of the above embodiments.

The technical solution of the present disclosure, by providing the locking member movably, enables the drive exciter to switch between the first state and the second state. In the first state, the vibration part is relatively fixed; in the second state, the vibration part abuts against the braking part, and the braking part brakes the vibration part to generate anisotropic vibrations. Since the generation of these anisotropic vibrations requires the cooperation of the braking part and the vibration part, the frequency of generating the vibrations depends on how often the vibration part moves and abuts against the braking part. Therefore, when the locking member continuously moves to switch between the first state and the second state, the vibration part intermittently abuts against the braking part, thereby generating the anisotropic vibrations discretely.

The technical solution of the present disclosure can significantly increase the asymmetry of the anisotropic vibrations and present asymmetric vibrations discretely over a short period of time. Moreover, by generating vibrations that closely resemble the actual asymmetric vibration forces, it is possible to discretely present a clear force sensation in a certain direction over a short period of time. The direction of this force sensation depends on the direction in which the braking part abuts against the vibration part, thereby no longer being limited to the manner of holding.

### BRIEF DESCRIPTION OF THE DRAWINGS

In order to clearly illustrate embodiments of the present disclosure or technical solutions in the prior art, accompanying drawings that need to be used in description of the embodiments or the prior art will be briefly introduced as follows. Obviously, drawings in following description are only the embodiments of the present disclosure. For those skilled in the art, other drawings can also be obtained according to the disclosed drawings without creative efforts.

FIG. 1 is a schematic structural diagram of one embodiment of the drive exciter according to the present disclosure;

FIG. 2 is a partial schematic structural diagram of one embodiment of the drive exciter according to the present disclosure;

FIG. 3 is a schematic structural diagram of a vibration part of one embodiment of the drive exciter according to the present disclosure;

FIG. 4 is partial schematic structural diagram in another perspective of the vibration part in FIG. 3;

FIG. 5 is a schematic structural diagram of an installation part of another embodiment of the drive exciter according to the present disclosure;

FIG. 6 is a schematic structural diagram of an energy storage stage of one embodiment of the drive exciter according to the present disclosure;

FIG. 7 is a schematic structural diagram of a releasing stage of one embodiment of the drive exciter according to the present disclosure;

FIG. 8 is a schematic structural diagram of a motion stage of one embodiment of the drive exciter according to the present disclosure;

FIG. 9 is a schematic structural diagram of a braking stage of one embodiment of the drive exciter according to the present disclosure;

FIG. 10 is a schematic structural diagram of a returning stage of one embodiment of the drive exciter according to the present disclosure;

FIG. 11 is a waveform diagram of an asymmetric signal for solid contact braking in the prior art.

Description of reference signs:

| No. | Name | No. | Name |
|---|---|---|---|
| 100 | drive exciter | 33 | vibration part |
| 10 | bracket | 34 | first yoke plate |
| 11 | installation member | 35 | second yoke plate |
| 111 | installation body | 37 | spring leaf |
| 111a | clearance hole | 39 | cushioning member |
| 113 | coverplate | 40 | braking part |
| 13 | guiding structure | 50 | latch part |
| 131 | guiderod | 51 | drive member |
| 15 | first connecting rack | 53 | locking member |
| 17 | second connecting | 55 | limiting member |
| | rack | | |
| 30 | vibration part | 55a | limiting groove |
| 31 | housing | 55b | notch |
| 311 | shaft liner | 60 | resetting member |

The realization of the purpose, functional features and advantages of the present disclosure will be further described in conjunction with the embodiments and with reference to the accompanying drawings.

### DETAILED DESCRIPTION

Technical solutions in the embodiments of the present disclosure are described below with reference to the accompanying drawings in the embodiments of the present disclosure. Apparently, the described embodiments are merely some rather than all of the embodiments of the present disclosure. All other embodiments, acquired by those of ordinary skill in the art based on the embodiments of the present disclosure without any creative work, should fall into the protection scope of the present disclosure.

It should be noted that all directional indications (such as up, down, left, right, front, rear . . . ) in the embodiments of the present disclosure is only used to explain the relative position relationship between the components under a particular attitude (as shown in the attached drawing), the motion, etc., and if the specific attitude changes, the directional indication will change accordingly.

In addition, descriptions involving “first”, “second”, etc., in the present disclosure are used solely for descriptive purposes and should not be construed as indicating or implying their relative importance or as implicitly specifying the number of the indicated technical features. Thus, features defined by “first”, “second”, etc., may explicitly or implicitly include at least one such feature. Furthermore, technical solutions from different embodiments can be combined, but must be based on what an ordinary skilled person in the art could achieve. When the combination of technical solutions results in mutual contradictions or impossibility of implementation, such combinations should be considered non-existent and outside the scope of protection claimed in the present disclosure.

The so-called “anisotropic vibration”, also known as “asymmetric vibration” creates a sensation for the user holding the vibration device of being pulled in a specific direction by inputting an asymmetric signal to the vibration apparatus such as a vibration motor, etc. Moreover, vibration apparatuses capable of achieving anisotropic vibration are commonly used in devices such as game controllers and provide users with excellent feedback through asymmetric vibration.

In the vibration apparatus involved in the technical solution of the present disclosure, the so-called “discrete” is a concept that contrasts with “continuous”. For example, after a single excitation, the vibration motor will continuously vibrate to output a continuous vibration to the vibration apparatus, such that the user feels a vibration or pulling sensation that lasts for a period of time, it is referred to as the continuous vibration; however, if the vibration apparatus outputs a clear vibration directed towards a specific direction once or multiple times at intervals over a period, it is referred to as the discrete anisotropic vibration.

It should also be noted that due to the relatively small equivalent force, the traditional vibration apparatus often need to continuously output vibrations within a certain frequency range to ensure that the user can clearly perceive the vibration, thus generating a pulling sensation. Since the vibrator of the vibration motor has spring plates connected to both ends thereof, even after a single excitation, residual vibrations will still occur in the vibration motor under the effect of the spring plates following a strong vibration of the vibrator.

As shown in FIG. 11, both diagrams in FIG. 11 illustrate that the waveform repeats in a certain cycle, this is because the pseudo-force sensation effect of “pulling in a certain direction” is generated through an asymmetric waveform that repeats at a constant period. In addition to the part of the waveform that contributes to generating the force sensation, there are many unnecessary vibrations, making this method unsuitable for producing discrete force sensations.

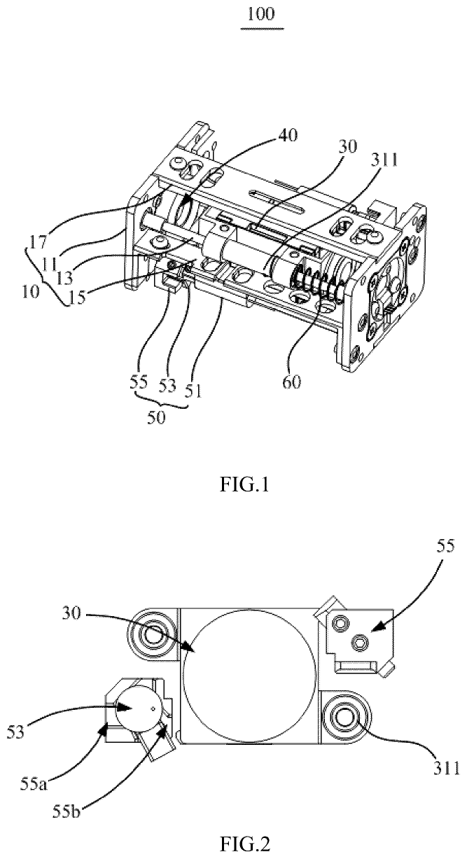

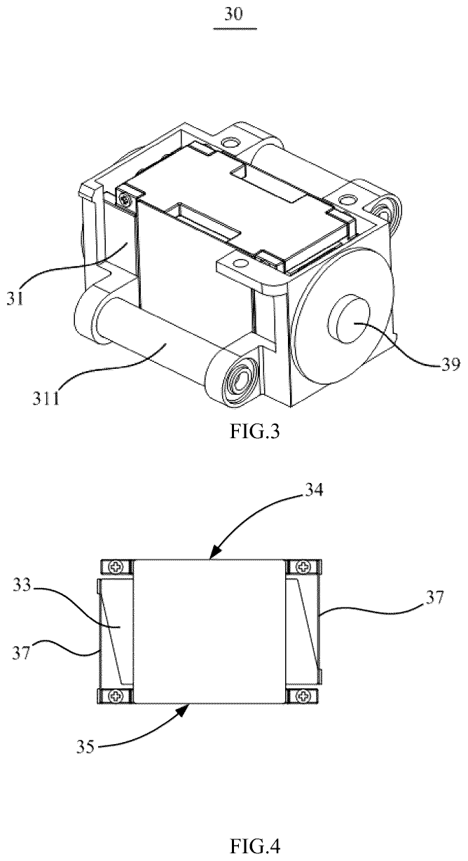

Referring to FIGS. 1 to 10, to achieve the objective of discretely presenting clear and definite anisotropic vibrations, the drive exciter 100 provided by the present disclosure includes a bracket 10, a vibration part 30, a braking part 40 and a latch part 50, and the bracket 10 includes an installation member 11 and a guiding structure 13 connected to the installation member 11; the vibration part 30 is movably connected to the guiding structure 13 and is provided with a vibratile vibration member 33; the braking part 40 is connected to the installation member 11 and is provided towards the vibration part 30; and the latch part 50 includes a drive member 51 connected to the installation member 11 and a latch member 53 connected to an output end of the drive member 51; the drive exciter 100 has a first state where the latch member 53 abuts against the vibration part 30 and a second state where the latch member 53 is disengaged from the vibration part 30, and in the second state, the vibration part 30 moves towards the braking part 40 and abuts against the braking part 40.

In one embodiment, the installation member 11 is generally plate-shaped, and the guiding structure 13 is provided on one side of the installation member 11 and is fixedly connected to it. The vibration part 30 can be a linear resonator, and is movably connected to the guiding structure 13. The braking part 40 is fixed to the surface of the installation member 11 facing towards the vibration part 30. Of course, the guiding structure 13 may be provided around the braking part 40 or may be provided on one side of the guiding part, which is not limited herein. Optionally, the guiding structure 13 may be one or more guiderods 131 connected to the installation member 11, and the vibration part 30 is sleeved onto the guiderod 131; the guiding structure 13 may be provided with a track groove, with the vibration part 30 slidably provided inside the track groove. Inside the vibration part 30, there is provided a vibration part 33 that vibrates in a certain direction. It can be understood that the vibration member 33 has a certain mass to possess sufficient energy during vibration.

In the present embodiment, the latch part 50 is provided on a side of the vibration part 30, wherein the drive member 51 may be a linear motor, solenoid, linear actuator, rotary motor, or other drive device, and drives the locking member 53 to approach or move away from the vibration part 30 either by translation or rotation.

Referring to FIGS. 6 to 10 in combination, in one embodiment, it is necessary for the drive exciter 100 to go through the following stages to produce a complete anisotropic vibration:

energy storage stage: referring to FIG. 6, inputting an electric drive signal to the vibration part 30, generating an excitation magnetic field in the vibration chamber so as to drive the vibration member 33 to vibrate continuously for storing energy, and at this point the drive exciter 100 is in the first state, and the locking member 53 abuts against the side surface of the vibration part 30 to relatively fix the vibration part 30 in the vibration direction of the vibration part 33;

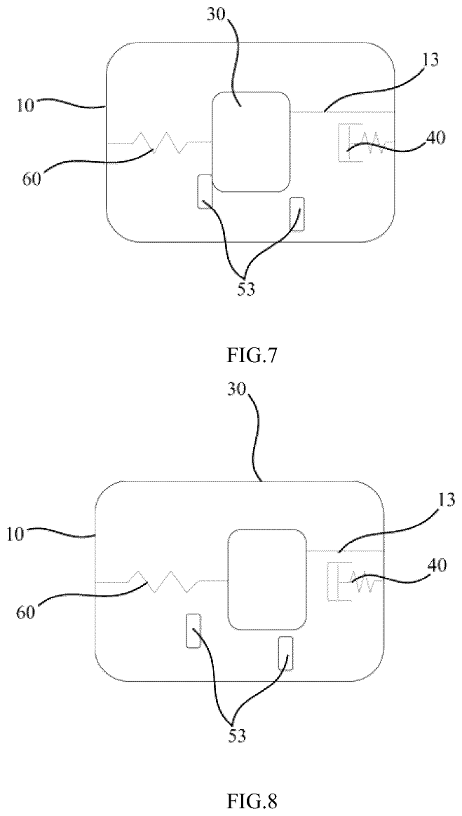

releasing stage: referring to FIG. 7, the drive member 51 drives the locking member 53 to translate or rotate until the locking member 53 is disengaged from the vibration part 30, causing the drive exciter 100 to transition to the second state;

motion stage: referring to FIG. 8, at this point, the drive exciter 100 is in the second state. The vibration part 30 is disengaged from the constraint of the locking member 53 and, under the drive of the internal vibration part 33, moves towards the braking part 40 provided on the installation member 11;

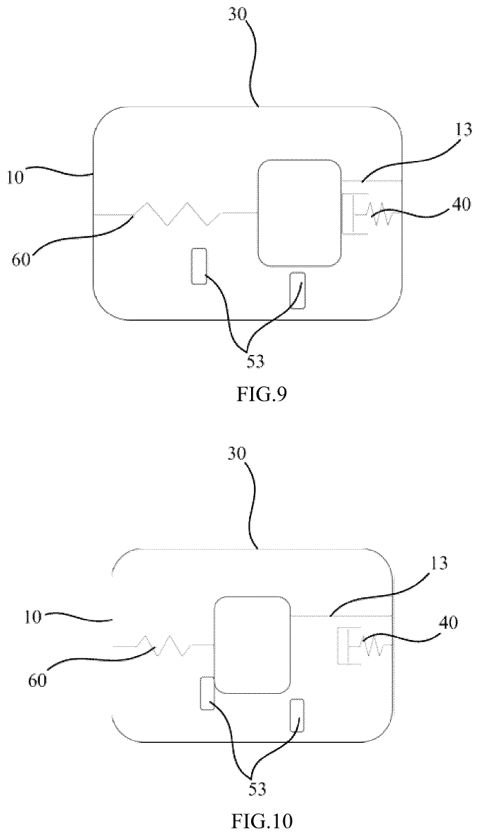

braking stage: referring to FIG. 9, the vibration part 30 abuts against the braking part 40, the braking part 40 receives the energy produced by the vibration of the vibration member 33, thereby producing the anisotropic vibrations and generating a pulling sensation or force sensation along a normal direction of the contact surface between them;

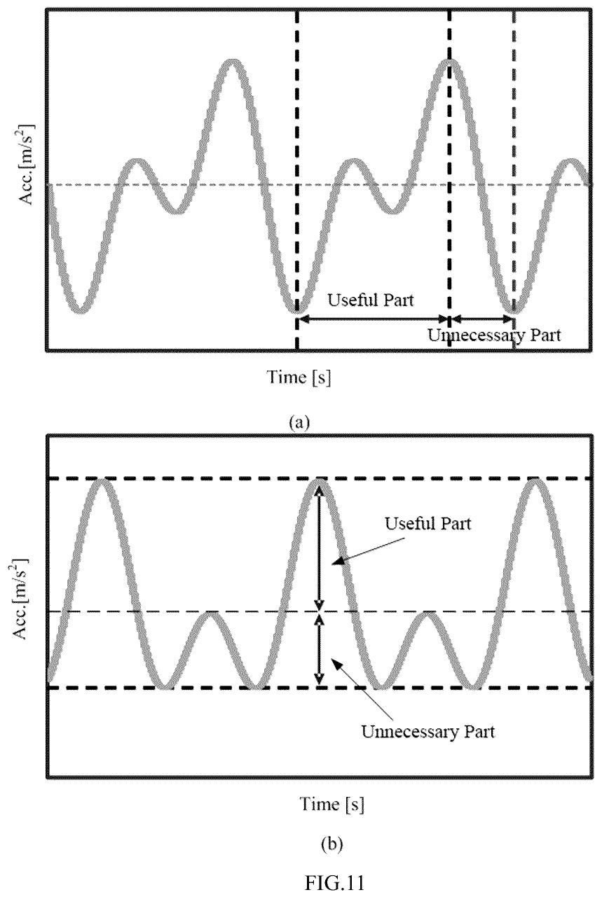

returning stage: referring to FIG. 10, after the anisotropic vibration is generated once, the vibration part 30 leaves the braking part 40, and the drive exciter 100 returns to the first state and waits for the next trigger, at which point the anisotropic vibration stops.

It can be understood that in the above embodiment, the generation of the anisotropic vibration does not originate from the vibration of the vibration part 30 itself, but rather from the cooperation between the braking part 40 and the vibration part 30. Specifically, the braking part 40 brakes the vibration part 30 to generate the anisotropic vibration, and when the vibration part 30 leaves the braking part 40, the anisotropic vibration stops.

After going through the above stages, the drive exciter 100 may generate the anisotropic vibration once. By repeating the above processes multiple times within a certain period, it is possible to discretely generate multiple instances of anisotropic vibration. Further, by controlling the motion frequency of the vibration part 30, it is possible to control the frequency of generating the anisotropic vibration. By changing parameters such as the mass of the vibration part 30 or the magnitude of the current, it is possible to change the magnitude of the anisotropic vibration.

The technical solution of the present disclosure, by providing the locking member 53 movably, enables the drive exciter 100 to switch between the first state and the second state. In the first state, the vibration part 30 is relatively fixed; in the second state, the vibration part 30 abuts against the braking part 40, and the braking part 40 brakes the vibration part 30 to generate anisotropic vibration. Since the generation of these anisotropic vibrations requires the cooperation of the braking part 40 and the vibration part 30, the frequency of generating the vibrations depends on how often the vibration part 30 moves and abuts against the braking part 40. Therefore, when the locking member 53 continuously moves to switch between the first state and the second state, the vibration part 30 abuts against the braking part 40 intermittently, thereby generating the anisotropic vibrations discretely.

The technical solution of the present disclosure can significantly increase the asymmetry of the anisotropic vibrations and present asymmetric vibrations discretely over a short period of time. Moreover, by generating vibrations that closely resemble the actual asymmetric vibration forces, it is possible to discretely present a clear force sensation in a certain direction over a short period of time. The direction of this force sensation depends on the direction in which the locking member 53 abuts against the vibration part 30, thereby no longer being limited to the manner of holding.

Referring to FIGS. 6 to 10, in one embodiment of the present disclosure, the latch part 50 includes two latch members 53, which are located on two sides of the vibration part 30 to form a limiting space, and the drive member 51 is connected to at least one of the latch members 53. In the first state, the vibration part 30 is limited within the limiting space.

In the present embodiment, the locking member 53 may be a block-like entity or a rod-like entity. The vibration direction of the vibration part 33 is defined as the left-right direction. Optionally, the braking part 40 is provided on the right side of the vibration part 33. Two locking members 53 are spaced apart left and right to form the above vibration space. Here, the locking member 53 on the left side is fixed in place, while the drive member 51 is connected to the locking member 53 on the right side, so as to drive the locking member 53 to rotate or translate, thereby allowing the drive exciter 100 to switch between the first state and the second state.

Specifically, in one embodiment of the present disclosure, the drive member 51 is provided with a rotation shaft, the latch member 53 is a locking rod, one end of the latch member 53 is connected to the rotation shaft, and a length direction of the latch member 53 is arranged at an angle with an extension direction of the rotation shaft. In the present embodiment, the drive member 51 is a rotating motor, the latch member 53 is a substantially L-shaped structural member, one branch of the latch member 531 is connected to the rotation shaft, and the rotation shaft rotates to enable the other branch of the latch member 53 to approach or be away from the vibration part 30. When the drive member 51 receives a designated signal, the rotation shaft drives the locking member 53 to rotate, until the locking member 53 abuts against the housing of the vibration part 30 or the locking member 53 is disengaged from the vibration part 30. This allows for simple and convenient realization the movement of the locking member 53 and switching between the first state and the second state.

However, in the embodiments of other aspects of the present disclosure, the drive member 51 drives the locking member 53 to perform linear motion, and a motion direction of the locking member 53 is arranged at an angle with the vibration direction of the vibration member 33. Optionally, the drive member 51 may be a linear motor, which includes a stator and a rotor. The stator is fixed in the bracket 10, the rotor is in sliding fit with the stator and moves along a straight line. The locking member 53 is connected to the rotor. Preferably, the straight line in which the motion direction of the locking member 53 is set at an angle of 90 degrees to the straight line where the vibration direction of the vibration member 33 is located. This arrangement is simple and effective, making the generation and transmission of vibrations more explicit and achieving good results.

Of course, the drive member 51 may also be other structures that can realize the above technical concept, and is not specifically limited. Accordingly, the structure of the locking member 53 may be modified based on the structure or spatial arrangement of the drive member 51, and is not limited.

Referring to FIG. 1, in one embodiment of the present disclosure, the bracket 10 further includes a first connecting rack 15 parallel to the guiding structure 13. The first connecting rack 15 is connected to the installation member 11, and the drive member 51 is fixed to the first connecting rack 15. The latch part 50 further includes a limiting member 55, the limiting member 55 is connected to the first connecting rack 15 and forms a limiting groove 55a. A sidewall of the limiting groove 55a is formed with a notch 55b facing towards the vibration part 30. One end of the latch member 53 connected to the drive member 51 extends into the limiting groove 55a, the other end of the latch member 53 away from the drive member 51 protrudes out of the notch 55b. The latch member 53 is rotated between two opposing sidewalls of the notch 55b.

In the present embodiment, the first connecting rack 15 is bolted to the surface of the installation member 11 and has a length direction. The length direction of the first connecting rack 15 is parallel to the vibration direction of the vibration part 33. The limiting member 55, the locking member 53, and the drive member 51 are all connected to the side surface of the first connecting rack 15. Further, to reduce the structural weight and ensure the vibration effect, the first connecting rack 15 is partially hollowed out.

In the present embodiment, referring to FIG. 2, the limiting member 55 is a structure similar to a bottle cap, with no specific limitations on its shape. A rabbet of the limiting groove 55a faces towards the locking member 53. The groove wall of the limiting groove 55a is provided with several notches 55b. The drive member 51 is a rotary motor. A part of the locking member 53 is provided within the limiting groove 55a, while another part passes through the notch 55b and protrudes out of the limiting groove 55a. It can be understood that the drive member 51 may drive the locking member 53 to rotate within the space between the two sidewalls of the notch 55b. When the locking member 53 abuts against one sidewall, it also just abuts against the vibration part 30; when the locking member 53 abuts against the other sidewall, it is disengaged from the vibration part 30. By additionally providing the limiting member 55 to restrict the movement range of the locking member 53, it helps to counteract the inertia of the locking member 53 to a certain extent and improves the working efficiency and stability of the locking member 53.

Referring to FIGS. 1, 3 and 4, in one embodiment of the present disclosure, the guiding structure 13 includes at least two guiderods 131 extending along a vibration direction of the vibration member 33, and ends of the guiderods 131 are fixed to the installation member 11.

The vibration part 30 includes a housing 31, a vibration member 33 and two elastic members 37. The housing 31 is provided with a shaft liner 311 at a side surface thereof, the shaft liner 311 is movably sleeved on the guiderod 131. The housing 31 encloses a vibration space, and the vibration member 33 is provided within the vibration space vibrationally. The two elastic members 37 are provided on two sides of the vibration member 33 along the vibration direction of the vibration member 33, and are connected to the housing 31 and an end of the vibration member 33.

In the present embodiment, the housing 31 includes two end caps arranged oppositely and a connecting plate provided between the two end caps for connecting them. Each end cap is provided with two mounting lugs provided on either side, and the mounting lug is provided with a clearance hole for the guiderod 131 to pass through. The mounting lugs of the two end caps are facing to each other and connected through the shaft liner 311.

The vibration part 33 vibrates in a certain direction within the vibration space. As the vibration part 33 vibrates, it simultaneously drives the elastic member 37 to vibrate and stores the generated energy in the elastic member 37. When the housing 31 abuts against the braking part 40, the stored energy is released to the braking part 40, generating the vibration wave. Since the vibration part 30 abuts against the braking part 40 from one side, the resulting vibration is also unilateral and exhibits significant asymmetry. That is to say, the pulling sensation in a certain direction is real and does not depend on the user's grip and sensory experience.

Further, referring to FIG. 4, in one embodiment of the present disclosure, the vibration part 30 further includes a first yoke plate 34 and a second yoke plate 35 which are oppositely provided and are fixedly connected to the housing 31. The elastic member 37 is a spring leaf, one end of the spring leaf is connected to the first yoke plate 34 or the second yoke plate 35, the other end of the spring leaf is connected to the end of the vibration member 33. Optionally, the vibration part 33 of the present embodiment has a substantially parallelogram cross section, the vibration direction of which is defined as the left-right direction and the up-down direction perpendicular to the left-right direction in the paper plane. The first yoke plate 34 is provided at the top, and the second yoke plate 35 is provided at the bottom. The upper left end of the vibration part 33 is connected to the second yoke plate 35, and the lower right end of the vibration part 33 is connected to the first yoke plate 34. When the vibration part 33 vibrates, its end drives the spring leaf to vibrate. This configuration allows for better use of the elasticity of the spring leaf, increasing the amplitude of the vibration part 33 and the spring leaf under equal conditions.

In one embodiment of the present disclosure, in order to protect the hardware and achieve a good vibration effect, the end of the housing 31 along the vibration direction of the vibration part 33 is provided with a cushioning member 39 facing towards the braking part 40, and the cushioning member 39 is a spring; or the cushioning member 39 is rubber; or the cushioning member 39 is foam; or the cushioning member 39 is composed of at least two of the spring, the rubber and the foam connected in series or in parallel.

Referring to FIG. 1, in one embodiment of the present disclosure, the drive exciter 100 further includes a resetting member 60, which is a spring. The two ends of the spring are elastically connected to the vibration part 30 and a surface of the installation member 11. By providing the resetting member 60, the vibration part 30 may be smoothly reset after the braking stage, thus restoring the drive exciter 100 to the first state.

Of course, the resetting member 60 is not limited to a spring, and may be other structures capable of resetting the vibration part 30.

In one embodiment of the present disclosure, the braking part 40 is a spring; or, the braking part 40 is rubber; or, the braking part 40 is foam; or, the braking part 40 is composed of at least two of a spring, rubber, and foam connected in series or in parallel. That is to say, two or three of the spring, rubber, and foam may be connected end-to-end sequentially to achieve good braking effects, or they may be provided in parallel to brake the vibration part 30 and ensure structural stability.

The braking part 40 may be additionally provided with two pressing plates, with the spring, rubber, and foam connected to the two pressing plates in parallel or in series. One pressing plate is connected to the installation member 11, and the other pressing plate is used to abut against the vibration part 30. In this way, it is possible to make the structure of the braking part 40 more stable and reliable.

In another embodiment of the present disclosure, the drive exciter 100 includes two installation members 11 arranged opposite to each other, two braking parts 40 arranged opposite to each other, and two latch parts 50 arranged opposite to each other. The two ends of the guiding structure 13 are connected to the two installation members 11. The two braking parts 40 are oppositely provided on the two installation members 11. Two latch parts 50 are provided in parallel on two sides of the vibration part 30, with one drive member 51 connected to one latch member 53. Each latch member 53 is provided between the vibration part 30 and the installation member 11 to form a limiting space. Here, in the first state, the vibration part 30 is limited within the limiting space.

In the present embodiment, at least one second connecting rack 17 is provided between the two installation members 11, with both ends of the second connecting rack connected to the installation member 11 respectively, to further ensure structural stability. The two locking members 53 may be provided on the same side or on opposite sides, and both locking members 53 are movable. However, in the second state, only one of the locking members 53 moves and is disengaged from the vibration part 30. For example, when the right-side locking member 53 moves, the left-side locking member 53 remains stationary, allowing the vibration part 30 to move to the right; when the left-side locking member 53 moves, the right-side locking member 53 remains stationary, allowing the vibration part 30 to move to the left. That is, in the second state, the vibration part 30 may only approach one of the braking parts 40, and the anisotropic vibrations generated by the vibration part 30 in cooperation with the two braking parts 40 are opposite to each other. In the present embodiment, the drive exciter 100 is capable of achieving movement of the vibration part 30 in different directions, and thus may present two anisotropic vibrations in opposite directions. It should be noted that these two vibrations do not coexist simultaneously.

Optionally, the guiding structure 13 is a guiderod 131, and there can be provided a plurality of guiderods 131 and a plurality of latching parts 50. The guiderods 131 and latching parts 50 are arranged alternately around the vibration part 30, ensuring that the number and position of the locking members 53 on two sides of the vibration direction of the vibration part 30 are the same and symmetrical, thus ensuring uniform force distribution and structural stability.

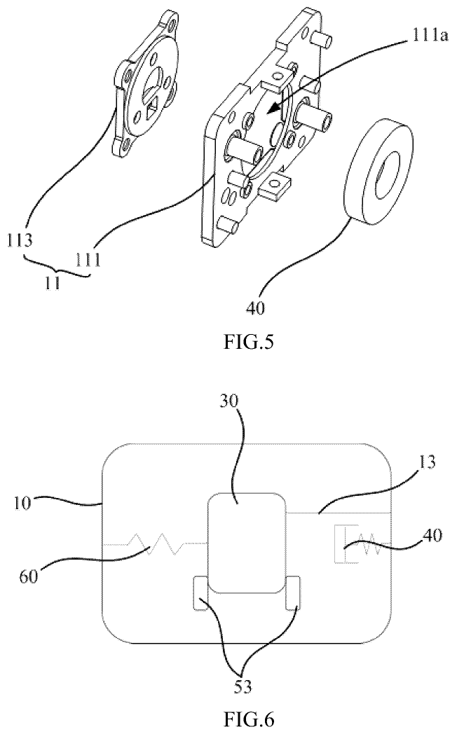

Referring to FIG. 5, in one embodiment of the present disclosure, the installation member 11 includes an installation body 111 and a coverplate 113. The installation body 111 is provided with an installation groove and a clearance hole 111a on the bottom wall of the installation groove, and the guiding structure 13 is connected to the installation body 111. The coverplate 113 seals the rabbet of the installation groove and is removably connected to the installation body 111. The braking part 40 is fixedly connected to the coverplate 113 through the clearance hole 111a. The coverplate 113 is bolted to the installation body 111, and the braking part 40 is glued or bolted to the coverplate 113. The interaction between the vibration part 30 and the braking part 40 will inevitably cause wear and tear on the hardware. In the present embodiment, it is possible to enable the replacement of the braking part 40 or maintenance of the equipment by removing the coverplate 113, making the process convenient and quick.

The present disclosure also relates to an electronic device, which includes the drive exciter 100 described in any of the above embodiments. The specific structure of the drive exciter 100 refers to the above embodiments. Since the electronic device adopts all the technical solutions of the above embodiments, it therefore possesses all the beneficial effects brought by the technical solutions of the above embodiments, which will not be elaborated herein.

Here, in some applications of the drive exciter 100, the electronic device may be a tactile device such as a handle or a VR all-in-one machine.

The above description is merely an optional embodiment of the present disclosure, and is not intended to limit the patent scope of the present disclosure. Any equivalent structural transformations made based on the inventive concept of the present disclosure using the contents of the specification and the accompanying drawings of the present disclosure, or their direct/indirect application in other related technical fields, shall fall within the scope of patent protection of the present disclosure.

1. A drive exciter, comprising:
a bracket comprising an installation member and a guiding structure connected to the installation member;
a vibration part movably connected to the guiding structure and provided with a vibration member;
a braking part connected to the installation member proximate to the vibration part; and
a latch part comprising a drive member connected to the installation member and a latch member connected to an output end of the drive member;
wherein, the drive exciter has a first state where the latch member abuts against the vibration part and a second state where the latch member is disengaged from the vibration part, and the vibration part is configured to moves towards the braking part and abuts against the braking part.

2. The drive exciter according to claim 1, wherein the latch part comprises two latch members, which are located on two sides of the vibration part to form a limiting space, with the drive member connected to at least one of the latch members;
wherein in the first state, the vibration part is limited within the limiting space.

3. The drive exciter according to claim 1, wherein the drive member is provided with a rotation shaft, with the latch member being a locking rod, a first end of the latch member being connected to the rotation shaft, and a length direction of the latch member being arranged at an angle with an extension direction of the rotation shaft.

4. The drive exciter according to claim 3, wherein the bracket further comprises a first connecting rack parallel to the guiding structure, the first connecting rack being connected to the installation member, and the drive member being fixed to the first connecting rack; and
the latch part further comprises a limiting member which is connected to the first connecting rack to form a limiting groove, a sidewall of the limiting groove formed with a notch facing towards the vibration part, a first end of the latch member connected to the drive member extending into the limiting groove, a second end of the latch member away from the drive member protruding out of the notch, and the latch member being rotated between two opposing sidewalls of the notch.

5. The drive exciter according to claim 1, wherein the guiding structure comprises at least two guiderods extending along a vibration direction of the vibration member, and ends of the guiderods are fixed to the installation member;
the vibration part comprises:
a housing provided with a shaft liner at a side surface thereof, the shaft liner being movably sleeved on the guiderods, and the housing enclosing a vibration space;
a vibration member provided within the vibration space vibrationally; and
two elastic members provided on two sides of the vibration member along the vibration direction of the vibration member, the elastic member being connected to the housing and an end of the vibration member.

6. The drive exciter according to claim 5, wherein the vibration part further comprises a first yoke plate and a second yoke plate which are oppositely provided and are fixedly connected to the housing, the elastic member being a spring leaf, one end of the spring leaf being connected to the first yoke plate or the second yoke plate, the other end of the spring leaf being connected to the end of the vibration member;
and/or, an end of the housing along the vibration direction of the vibration member is provided with a cushioning member facing towards the braking part.

7. The drive exciter according to claim 1, further comprises a resetting member, comprising a spring, wherein two ends of the spring are elastically connected to the vibration part and a surface of the installation member.

8. The drive exciter according to claim 1, wherein the braking part comprises a spring;
or, the braking part comprises rubber;
or, the braking part comprises foam;
or, the braking part comprises at least two of a spring, rubber, and foam connected in series or in parallel.

9. The drive exciter according to claim 1, wherein the drive exciter comprises two installation members opposite to each other, two braking parts opposite to each other, and two latch parts opposite to each other, with two ends of the guiding structure connected to the two installation members;
the two braking parts are oppositely provided on the two installation members;
the two latch parts are provided in parallel on two sides of the vibration part, one drive member is connected to one latch member, and each latch member is provided between the vibration part and the installation member to form a limiting space;
wherein in the first state, the vibration part is limited within the limiting space.

10. An electronic device, comprising a drive exciter according to claim 1.
